(19) United States
(12) Patent Application Publication
(10) Pub. No.: US 2013/0119040 A1
(43) Pub. Date: May 16, 2013

(54) SYSTEM AND METHOD FOR ADAPTIVE FILL WELDING USING IMAGE CAPTURE

(71) Applicants: Heath Allen Suraba, Avon, OH (US); Geoffrey M. Lipnevicius, Sagamore Hills, OH (US)

(72) Inventors: Heath Allen Suraba, Avon, OH (US); Geoffrey M. Lipnevicius, Sagamore Hills, OH (US)

(73) Assignee: Lincoln Global, Inc., City of Industry, CA (US)

(21) Appl. No.: 13/294,568

(22) Filed: Nov. 11, 2011

(51) Int. Cl. B23K 9/095

(52) U.S. Cl. 219/137 R; 219/136

(57) ABSTRACT

A computer obtains a first image including a first portion of a first edge and a first portion of a second edge, wherein distance between the first portion of the first edge and the first portion of the second edge forms a first width of a seam between the first edge and the second edge. The computer obtains a second image including a second portion of the first edge and a second portion of the second edge, wherein distance between the second portion of the first edge and the second portion of the second edge forms a second width of the seam between the first edge and the second edge. The computer determines a parameter for a welding torch to weld a joint for joining the first edge and the second edge along the seam based at least in part on the first image and the second image.

### FIELD OF INVENTION

The present disclosure relates to the field of welding. More particularly, the present disclosure relates to a system and method for adaptive fill welding of a seam using image capture.

### BACKGROUND

Welding is a technique used to join two metals together. A welding torch applies an electric current to the metals at a gap or seam in order to heat and melt the metals. As the metals cool, they combine to form a joint. The welding torch can be controlled and directed into proper position to perform the weld manually by an operator. Alternatively, a welding torch may be controlled by a robot, such as an Arc Mate® welding robot manufactured by Fanuc Robotics.

A fit-up, or the bringing together of two metals to form a seam in preparation for a weld, may result in a non-uniform seam. For example, because of the slight variances that may be present in the edges of two metals being brought together, the resulting seam may have a first width at a first end and may have a second width at a second end. Further, a seam formed between a first pair of metals may not be identical to a seam formed by a second pair of metals. An operator may be required to make adjustments to the weld process to account for such seam or gap variances in order to produce a satisfactory weld. It may be labor intensive and costly for an operator to adjust for seam variances, however. Additionally, not adjusting for the variances may result in unsatisfactory welds which may require rework and thus incur further costs.

A welding robot may use a laser to detect variances and adjust a weld process automatically. A welding robot equipped with a laser may be expensive however, and may not be available to an operator. A welding robot may use a camera to take a picture of a seam in order to determine the shape of the seam and then to move a welding torch according to the determined shape. The welding robot, however, may not have sufficient information, based on the single image, necessary to make adjustments to account for gap variances.

### SUMMARY OF THE INVENTION

In a method for adaptive fill welding of a seam, a computer obtains a first image including a first portion of a first edge and a first portion of a second edge, wherein distance between the first portion of the first edge and the first portion of the second edge forms a first width of a seam between the first edge and the second edge. The computer obtains a second image including a second portion of the first edge and a second portion of the second edge, wherein distance between the second portion of the first edge and the second portion of the second edge forms a second width of the seam between the first edge and the second edge. The computer determines a parameter for a welding torch attached to a welding robot to weld a joint for joining the first edge and the second edge along the seam based at least in part on the first image and the second image. The computer causes the welding torch attached to the welding robot to weld the joint according to the determined parameter.

In a method for determining parameters for a welding robot to fill weld a workpiece, a computer obtains data representing at least two images including portions of a seam between surfaces of a workpiece and including portions of the surfaces of the workpiece adjacent to the seam, wherein width of the seam varies along the seam. The computer transforms the data representing the at least two images to data representing the width of the seam at the portions of the seam included in the at least two images. The computer determines a parameter of the welding robot's trajectory for a welding torch attached to a welding robot to weld a fill joint along the seam based at least in part on the data representing the width of the seam at the portions of the seam included in the at least two images.

A system for determining parameters for controlling a welding robot for adaptive fill welding has a means for obtaining, from a camera, a first image including a first portion of a first edge and a first portion of a second edge, wherein distance between the first portion of the first edge and the first portion of the second edge forms a first width of a seam between the first edge and the second edge. The system has a means for obtaining, from a camera, a second image including a second portion of the first edge and a second portion of the second edge, wherein distance between the second portion of the first edge and the second portion of the second edge forms a second width of the seam between the first edge and the second edge. The system has a means for determining a parameter for a welding torch attached to a welding robot to weld a joint for joining the first edge and the second edge along the seam based at least in part on the first image and the second image. The system has a means for causing the welding torch attached to the welding robot to weld the joint according to the determined parameter.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates an example welding system for adaptive fill welding.

FIG. 2 illustrates an example seam weld.

FIG. 3 illustrates an example lap weld.

FIG. 4 illustrates a block diagram of an example controller for determining parameters for controlling a welding robot for adaptive fill welding.

FIG. 5 is a flow chart illustrating an example method for adaptive fill welding.

FIG. 6 is a block diagram of an example computing device for implementing an example controller of a system for determining parameters for controlling a welding robot for adaptive fill welding.

### DETAILED DESCRIPTION

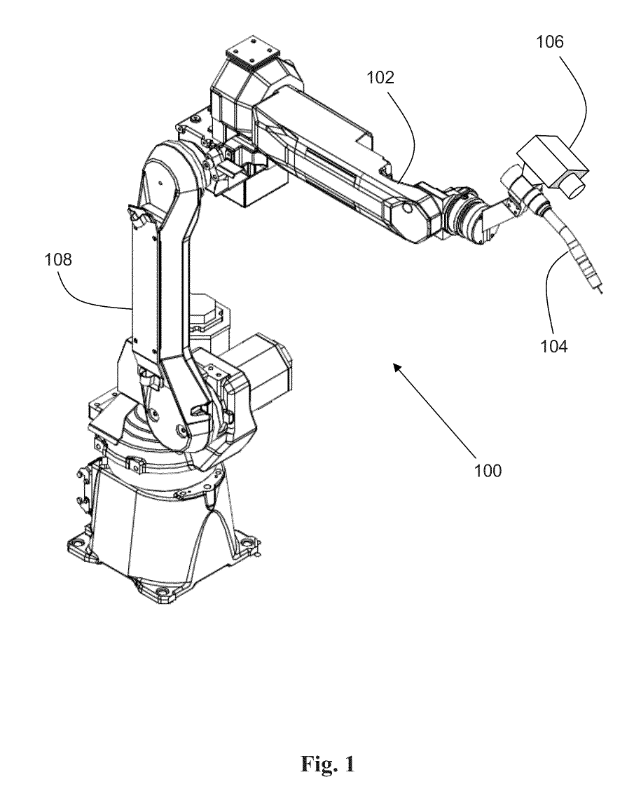

FIG. 1 is an example welding system 100 for adaptive fill welding. Welding system has a welding robot 102 coupled to a welding torch 104 for moving welding torch 104 along a seam to be welded. Welding torch 104 is configured to apply an arc weld, or other similar type of weld, to a seam between a first edge and a second edge to form a joint.

Welding system 100 includes a camera 106 for capturing images of a seam to be welded. It should be understood that although FIG. 1 illustrates camera 106 coupled to the top of welding torch 104, camera 106 may also be coupled to the bottom of welding torch 104 or at any other location on welding torch 104. In an example embodiment, camera 106 may be coupled to welding robot 102 at a location such that camera 106 is positioned to capture images of the seam to be welded.

Welding system 100 has a controller 108 for obtaining images from camera 106. Controller 108 is configured to determine parameters for welding the joint, based on the obtained images by examining the width of the seam or joint to be welded, as depicted in the images. Controller 108 is also configured to control welding robot 102 to weld the joint based on the determined parameters. Parameters for welding a joint or a seam may change depending on the width or volume of the seam. By comparing the width of the seam at a first end with the width of the seam at a second end, controller 108 is configured to determine how the width of he seam changes along the entire length of the seam. Accordingly, controller 106 is configured to adjust parameters such as the travel speed, the weave amplitude, and travel frequency of welding robot 102 and welding torch 104 as the volume or width of the seam changes.

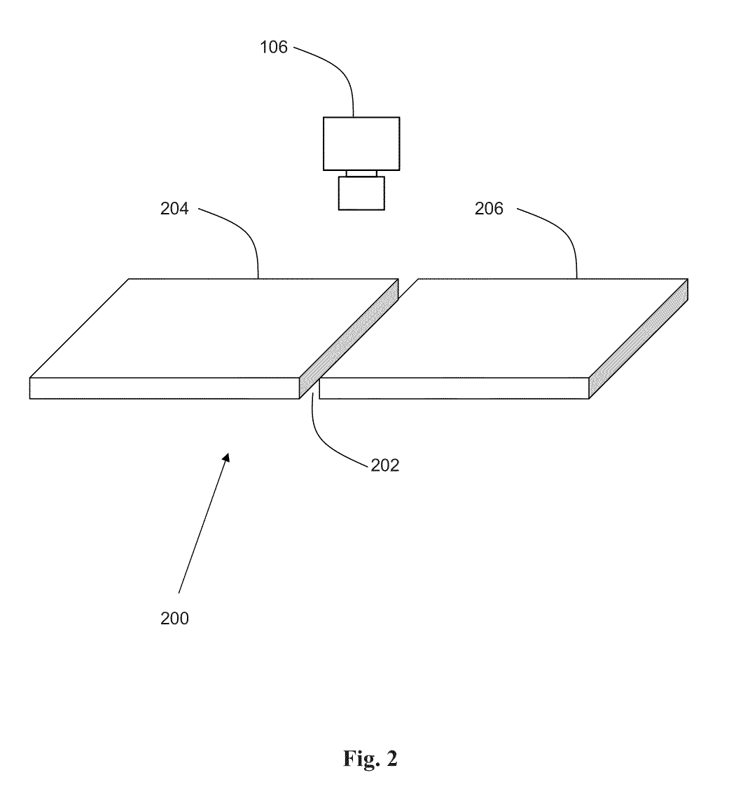

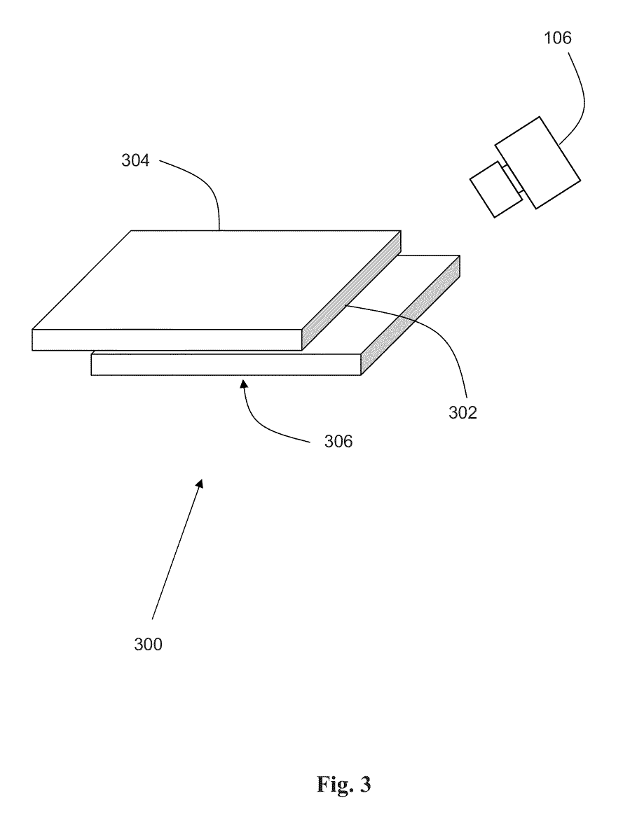

FIG. 2 illustrates an example seam weld 200. Camera 106 is positioned above a seam 202 or a gap created when a first object 204 adjoins along side a second object 206. Objects 204 and 206 may be metals, for example. Camera 106 is positioned to capture an image of seam 202. Alternatively, as illustrated in the example lap weld of FIG. 3, camera 106 may be rotated and positioned to capture an image of a seam 302 created when a first object 304 overlaps a second object 306.

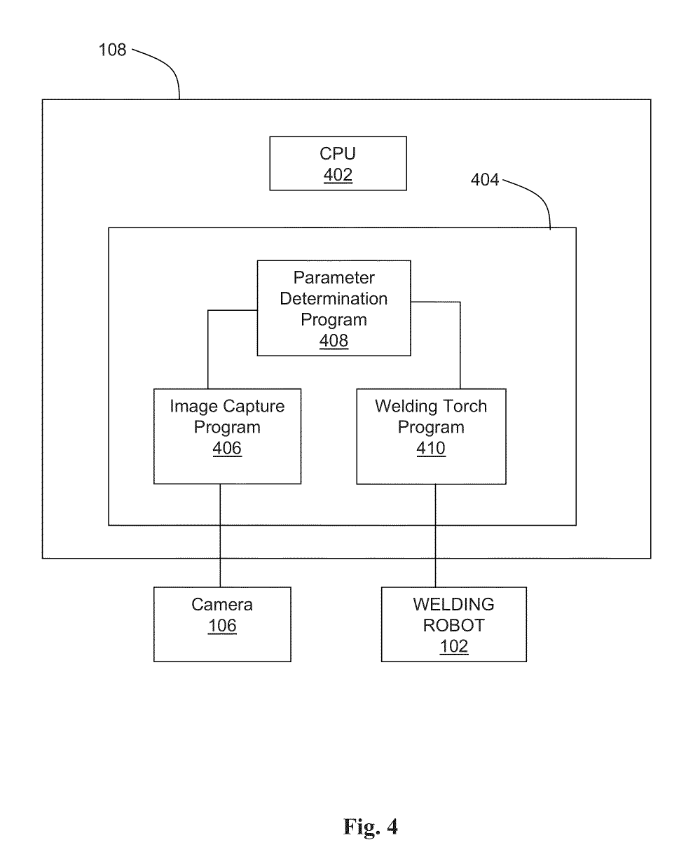

FIG. 4 illustrates a block diagram of an example controller 108 for determining parameters for controlling a welding robot 102 for adaptive fill welding. Controller 108 has a processor 402 for executing programs stored on tangible storage device 404. Tangible storage device 404 may be a computer readable medium such as a floppy disk drive, a hard disk drive, an optical disk drive, a tape device, a flash memory, or other solid state memory device.

Controller 108 has an image capture program 406 for obtaining images from camera 106. Image capture program 406 is configured to obtain a first image including a first portion of a first edge and a first portion of a second edge. The distance between the first portion of the first edge and the first portion of the second edge forms a first width of a seam between the first edge and the second edge.

Image capture program 406 is configured to obtain a second image including a second portion of the first edge and a second portion of the second edge. The distance between the second portion of the first edge and the second portion of the second edge forms a second width of the seam between the first edge and the second edge.

In an example embodiment, image capture program 406 is configured to obtain the first and second images by receiving data representative of the images in pixel form. In such an embodiment, image capture program 406 is configured to determine the seam width in pixel unit form. Based on a predetermined scale factor, image capture program 406 is configured to convert the seam width, as measured in pixels, into millimeters.

In an example embodiment, image capture program 406 is configured to obtain a first image including a shadow of one of the first portion of the first edge and the first portion of the second edge. Image capture station 406 may be similarly configured to obtain a second image including a shadow of one of the second portion of the first edge and the second portion of the second edge.

It should be understood that although image capture program 406 has been described as being configured to obtain a first and a second image, image capture program 406 may be configured to obtain more than two images for a seam. In an example embodiment, image capture program 406 may be configured to continuously obtain images of a seam, at predefined time or distance intervals, for example, as welding torch 102 performs a weld on the seam.

Controller 108 has a parameter determination program 408 for determining parameters for a welding torch attached to a welding robot to weld a joint for joining the first edge and the second edge along the seam. Parameter determination program 408 is configured to determine the parameters based at least in part on obtained first and second images.

Parameter determination program 408 is configured to analyze a first image obtained at a first end of a seam and a second image obtained at a second end of a seam and to determine, based on the images, the widths of the seam at the first and the second ends. Using that information, parameter determination program 408 is configured to calculate the width of the seam along the entire length of the seam. Based on the calculation, parameter determination program 408 is configured to make adjustments to weld parameters used by welding torch 102. For example, parameter determination program 408 is configured to adjust the weave amplitude, the travel speed and the travel frequency of welding torch 102. Additionally, parameter determination program 408 may be configured to adjust the speed at which wire is fed to welding torch 102 and the arc length of the weld being performed by welding torch 102.

In an example embodiment, parameter determination program 408 is configured to determine the parameters based at least in part on contrast between the shadow of one of the first portion of the first edge and the first portion of the second edge and the rest of the first image and contrast between the shadow of the one of the second portion of the first edge and the second portion of the second edge and the rest of the second image.

In an example embodiment, for a lap weld, parameter determination program 408 is configured to determine a gap height between two overlapping objects and use the gap height to determine parameters for a weld. For example, parameters determination program 408 may be configured to determine a gap height at a first overlapping end and to determine a gap height at a second overlapping end. Parameter determination program 408 may be configured to use the two gap heights to calculate the gap height along the entire length of the overlap and adjust the parameters accordingly.

Controller 108 has welding torch program 410 for causing welding torch 102 attached to a welding robot to weld a joint according to determined parameters. For example, welding torch program 410 may be configured to cause welding torch 102 to ramp up and down the weave amplitude and travel speed as it moves across and welds a seam.

It should be understood that although FIG. 4 depicts controller 108 having a single processor 402 and a single tangible storage device 404, controller 108 may also have more then one processor (not shown) and more then one tangible storage device (not shown).

It should be further understood that although the example welding system 100 for adaptive fill welding has been described to include controller 108, welding system 100 for adaptive fill welding may alternatively include a laptop, a desktop computer, handheld computer, a tablet computer, a server, or another similar type of computing devices, capable of executing image capture program 406, parameter program 408, and welding torch program 410.

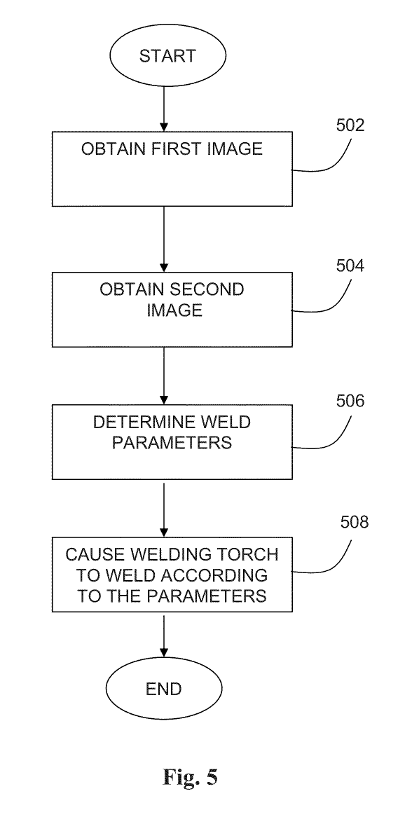

FIG. 5 is a flow chart illustrating an example method for adaptive fill welding of a seam. At step 502, image capture program 406 obtains a first image including a first portion of a first edge and a first portion of a second edge, wherein the distance between the first portion of the first edge and the first portion of the second edge forms a first width of a seam between the first edge and the second edge.

At step 504, image capture program 406 obtains a second image including a second portion of the first edge and a second portion of the second edge, wherein distance between the second portion of the first edge and the second portion of the second edge forms a second width of the seam between the first edge and the second edge.

In an example embodiment, the first width of the seam and the second width of the seam are different widths. In an example embodiment, image capture program 406 obtains digital photographs from camera 106.

At step 506, parameter determination program 408 determines a parameter for a welding torch 102 attached to a welding robot to weld a joint for joining the first edge and the second edge along the seam based at least in part on the first image and the second image.

At step 508, welding torch program 410 causes the welding torch 102 attached to the welding robot to weld the joint according to the determined parameter.

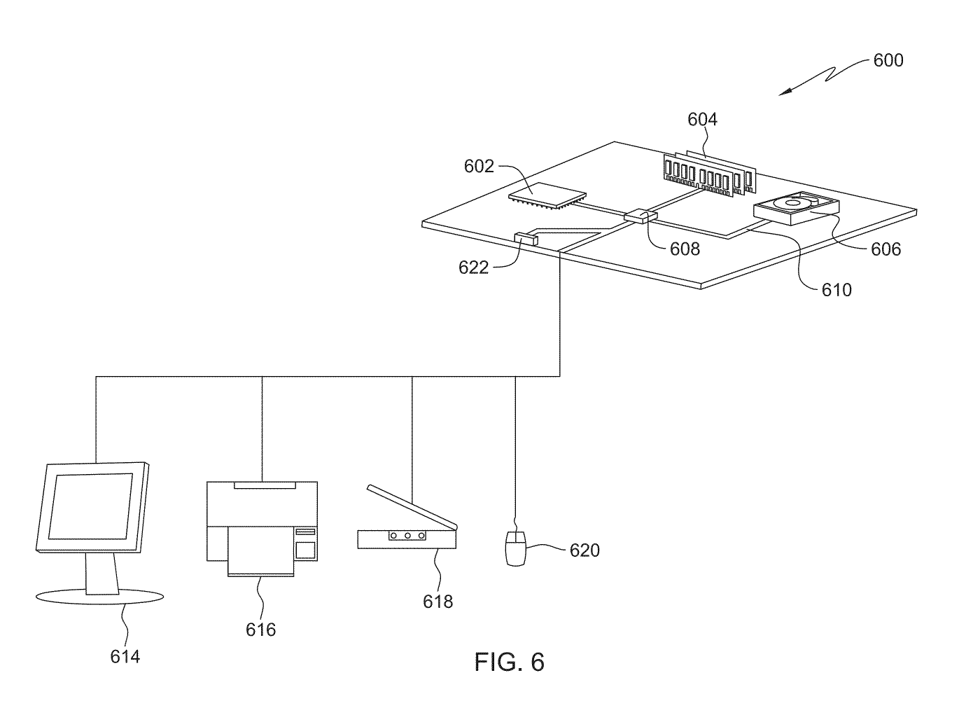

FIG. 6 is a block diagram of an example computer system 600 for implementing an example controller of a system for determining parameters for controlling a welding robot for adaptive fill welding. Computer system 600 is intended to represent various forms of digital computers, including laptops, desktops, handheld computers, tablet computers, servers, and other similar types of computing devices. Computer system 600 includes a processor 602, memory 604, a storage device 606, and a communication port 622, connected by an interface 608 via a bus 610.

Storage device 606 stores image capture program 406, parameter determination program 408, and welding torch program 410.

Processor 602 processes instructions, via memory 604, for execution within computer system 600, including image capture program 406, parameter determination program 408, and welding torch program 410 stored on storage device 606. In an example embodiment, multiple processors along with multiple memories may be used. In an example embodiment, multiple computer systems 600 may be connected, with each device providing portions of the necessary operations.

Memory 604 may be volatile memory or non-volatile memory. Memory 604 may be a computer-readable medium, such as a magnetic disk or optical disk. Storage device 606 may be a computer-readable medium, such as floppy disk devices, a hard disk device, and optical disk device, a tape device, a flash memory, or other similar solid state memory device, or an array of devices, including devices in a storage area network of other configurations. A computer program product can be tangibly embodied in a computer readable medium such as memory 604 or storage device 606. The computer program product may contain image capture program 406, parameter determination program 408, and welding torch program 410 program.

Computer system 600 can be coupled to one or more input and output devices such as a display 614, a scanner 618, a printer 616, and a mouse 620.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

Some portions of the detailed descriptions are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A method for method for adaptive fill welding of a seam, the method comprising the steps of:
a computer obtaining a first image including a first portion of a first edge and a first portion of a second edge, wherein distance between the first portion of the first edge and the first portion of the second edge forms a first width of a seam between the first edge and the second edge;
the computer obtaining a second image including a second portion of the first edge and a second portion of the second edge, wherein distance between the second portion of the first edge and the second portion of the second edge forms a second width of the seam between the first edge and the second edge;
the computer determining a parameter for a welding torch attached to a welding robot to weld a joint for joining the first edge and the second edge along the seam based at least in part on the first image and the second image; and
the computer causing the welding torch attached to the welding robot to weld the joint according to the determined parameter.

2. The method of claim 1, wherein the first width of the seam and the second width of the seam are different widths.

3. The method of claim 1, wherein the computer obtaining the first image includes the computer receiving a digital photograph of the first portion of the first edge and the first portion of the second edge, and wherein the computer obtaining the second image includes receiving a digital photograph of the second portion of the first edge and the second portion of the second edge.

4. The method of claim 1, wherein the computer obtaining the first image and the second image includes the computer obtaining data representing the first image and the second image in pixels.

5. The method of claim 4, further comprising the step of the computer transforming at least some of the data representing the first image and the second image in pixels to data representing at least some of the first image and the second image in units of distance.

6. The method of claim 1:
wherein the computer obtaining the first image includes the computer obtaining an image including a shadow of one of the first portion of the first edge and the first portion of the second edge;
wherein the computer obtaining the second image includes the computer obtaining an image including a shadow of one of the second portion of the first edge and the second portion of the second edge; and
wherein the computer determines the parameter based at least in part on:
contrast between the shadow of the one of the first portion of the first edge and the first portion of the second edge and the rest of the first image, and
contrast between the shadow of the one of the second portion of the first edge and the second portion of the second edge and the rest of the second image.

7. The method of claim 1 wherein the parameter include at least one of travel speed, travel frequency, wire feed speed, and arc length.

8. A method for determining parameters for a welding robot to fill weld a workpiece, the method comprising:
a computer obtaining data representing at least two images including portions of a seam between surfaces of a workpiece and including portions of the surfaces of the workpiece adjacent to the seam, wherein width of the seam varies along the seam;
the computer transforming the data representing the at least two images to data representing the width of the seam at the portions of the seam included in the at least two images; and
the computer determining a parameter of the welding robot's trajectory for a welding torch attached to a welding robot to weld a fill joint along the seam based at least in part on the data representing the width of the seam at the portions of the seam included in the at least two images.

9. The method of claim 8, wherein the parameter includes at least one of weave amplitude, travel speed, and travel frequency.

10. The method of claim 8, further comprising the step of the computer determining at least one of wire feed speed, arc length, and weld volume based at least in part on the data representing the width of the seam at the portions of the seam included in the at least two images.

11. The method of claim 8, further comprising the step of the computer controlling the welding robot based on the determined parameter.

12. The method of claim 8, wherein the computer obtaining data representing the at least two images includes the computer receiving the data from at least one camera operably connected to the welding robot to take digital images including the portions of the seam and the portions of the surfaces.

13. The method of claim 8, wherein the computer obtaining the data representing the at least two images includes the computer obtaining data representing the at least two images in pixels, and wherein the computer transforming the data representing the at least two images to data representing the width of the seam at the portions of the seam included in the at least two images includes the computer transforming the data representing the at least two images in pixels to data representing distance between the portions of the surfaces of the workpiece adjacent to the seam.

14. The method of claim 8, wherein the computer obtaining the data representing the at least two images includes the computer obtaining data representing an image including a shadow of one of the portions of the surfaces of the workpiece adjacent to the seam, wherein the computer determining parameters includes the computer determining the parameters based at least in part on contrast between the shadow and the rest of the image.

15. A system for determining parameters for controlling a welding robot for adaptive fill welding, the system comprising:
means for obtaining, from a camera, a first image including a first portion of a first edge and a first portion of a second edge, wherein distance between the first portion of the first edge and the first portion of the second edge forms a first width of a seam between the first edge and the second edge;
means for obtaining, from a camera, a second image including a second portion of the first edge and a second portion of the second edge, wherein distance between the second portion of the first edge and the second portion of the second edge forms a second width of the seam between the first edge and the second edge;
means for determining a parameter for a welding torch attached to a welding robot to weld a joint for joining the first edge and the second edge along the seam based at least in part on the first image and the second image; and
means for causing the welding torch attached to the welding robot to weld the joint according to the determined parameter.

16. The system of claim 15, wherein the parameters for controlling the welding robot include at least one of weave amplitude, travel speed, travel frequency, wire feed speed, and arc length.

17. The system of claim 15,
wherein the means for obtaining the first image includes obtaining an image including a shadow of one of the first portion of the first edge and the first portion of the second edge;
wherein the means for obtaining the second image includes obtaining an image including a shadow of one of the second portion of the first edge and the second portion of the second edge; and
wherein the means for determining the parameter determines the parameter based at least in part on:
contrast between the shadow of the one of the first portion of the first edge and the first portion of the second edge and the rest of the first image, and
contrast between the shadow of the one of the second portion of the first edge and the second portion of the second edge and the rest of the second image.

18. The system of claim 15, wherein the means for determining the parameter is configured to transform data representing the width of the seam in pixels to data representing the width of the seam in absolute or relative distance.
